(19) United States
(12) Patent Application Publication
(10) Pub. No.: US 2015/0248641 A1
(43) Pub. Date: Sep. 3, 2015

(54) ANALYZING CAREER DATA TO CREATE CUSTOMIZED CAREER FEEDBACK

(71) Applicant: International Business Machines Corporation, Armonk, NY (US)

(72) Inventors: Paul R. Bastide, Boxford, MA (US); Lisa Seacat DeLuca, Baltimore, MD (US); Lydia M. Do, Raleigh, NC (US)

(73) Assignee: International Business Machines Corporation, Armonk, NY (US)

(21) Appl. No.: 14/195,269

(22) Filed: Mar. 3, 2014

(51) Int. Cl. G06Q 10/10; G06Q 50/00; G06Q 50/20

(52) U.S. Cl. CPC G06Q 10/10; G06Q 50/2057; G06Q 50/01

(57) ABSTRACT

In a method for analyzing a career opportunity to generate feedback for a user, one or more processors determine at least one career opportunity. One or more processors receive a set of data for a user. One or more processors compare the at least one career opportunity to the set of data. One or more processors suggest at least one revision to the set of data based, at least in part, on a result of comparing the at least one career opportunity to the set of data, wherein the result indicates whether there is a match, at least in part, between the at least one career opportunity and the set of data.

### FIELD OF THE INVENTION

The present invention relates generally to social networking services, and more particularly to generating customized feedback for a user.

### BACKGROUND OF THE INVENTION

A professional networking service, or professional network, is a type of social networking service that focuses primarily on interactions and relationships of a business nature rather than including personal and non-business interactions. A professional network provides an opportunity to connect professionals within a particular field. A user may create a profile on the professional network that describes the user's professional experience and qualifications. For example, the user may upload a curriculum vitae or résumé (hereinafter both documents will be collectively referred to as a “CV”). The CV may recap major activities, events and accomplishments of the user. The user may update the CV when the user enters the job market to reflect his or her most recent and meaningful employment-related accomplishments.

A professional network may provide a database of employment opportunities. A user can search the employment opportunities in the database provided by the professional network. The professional network may also suggest employment opportunities to the user based on details in the user's CV. For example, the professional network may notify the user of employment opportunities that match the user's qualifications and accomplishments included in the user's CV.

The user may also interact with other users through the professional network. The user may, for example, view profiles of other users and send messages to other users. Users can use the professional network to communicate with each other about employment opportunities and business solutions. The professional network may also host professional groups that users can join and use for communication and collaboration. Recruiters can use professional networks to identify users who qualify for employment opportunities.

### SUMMARY

Aspects of embodiments of the present invention disclose a method, computer program product, and computer system for analyzing a career opportunity to generate feedback for a user. The method includes one or more processors determining at least one career opportunity. The method further includes one or more processors receiving a set of data for a user. The method further includes one or more processors comparing the at least one career opportunity to the set of data. The method further includes one or more processors suggesting at least one revision to the set of data based, at least in part, on a result of comparing the at least one career opportunity to the set of data, wherein the result indicates whether there is a match, at least in part, between the at least one career opportunity and the set of data.

### BRIEF DESCRIPTION OF THE SEVERAL VIEWS OF THE DRAWINGS

FIG. 1 is a functional block diagram illustrating a distributed data processing environment, in accordance with one embodiment of the present invention.

FIG. 2 is a flowchart depicting operational steps of a career feedback program, executing within the environment of FIG. 1, for analyzing a career opportunity to generate feedback for a user based on the user's current skills and career goals, in accordance with one embodiment of the present invention.

FIG. 3 depicts a block diagram of components of the server computer and the client computer of FIG. 1, in accordance with one embodiment of the present invention.

### DETAILED DESCRIPTION

A career navigation system provides automated coaching to a user that identifies a path to the user's desired career goal. The career navigation system also provides general feedback to the user that helps the user remain on the path toward the user's career goal. For example, a career navigation system may provide general suggestions, such as updating a CV. Embodiments of the present invention analyze a user's career goals and current skills and suggest customized career feedback. The career navigation system (or module) may be fully integrated, partially integrated or completely separate from the professional network system.

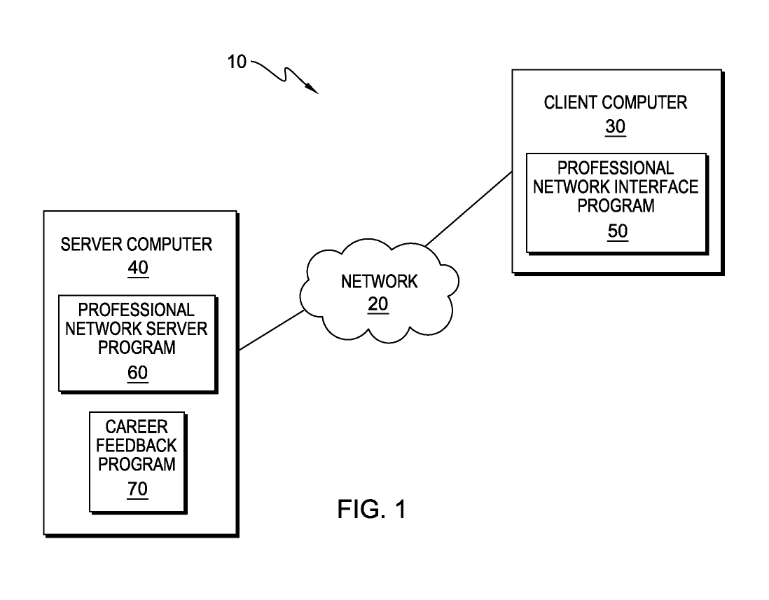

The present invention will now be described in detail with reference to the Figures. FIG. 1 depicts a diagram of distributed data processing environment 10 in accordance with one embodiment of the present invention. FIG. 1 provides only an illustration of one embodiment and does not imply any limitations with regard to the environments in which different embodiments may be implemented.

Distributed data processing environment 10 includes client computer 30 and server computer 40 interconnected over network 20. Network 20 may be a local area network (LAN), a wide area network (WAN) such as the Internet, a combination of the two or any combination of connections and protocols that will support communications between client computer 30 server computer 40 in accordance with embodiments of the present invention. Network 20 may include wired, wireless, or fiber optic connections. Distributed data processing environment 10 may include additional server computers, client computers, or other devices not shown.

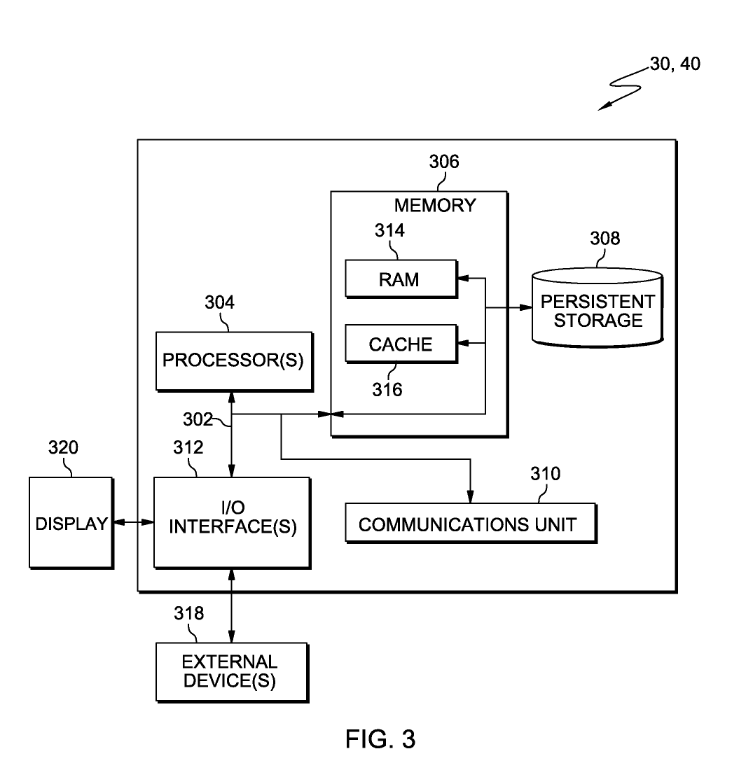

Client computer 30 may be a desktop computer, laptop computer, tablet computer, personal digital assistant (PDA), or smart phone. In general, client computer 30 may be any electronic device or computing system capable of processing computer program instructions, sending and receiving data, and communicating with server computer 40 over network 20, in accordance with embodiments of the present invention. In the depicted embodiment, client computer 30 includes professional network interface program 50. In one embodiment, client computer 30 includes components described in reference to FIG. 3.

Server computer 40 may be a management server, a web server, or any other electronic device or computing system capable of processing computer program instructions and receiving and sending data. In the depicted embodiment, server computer 40 may represent a server computing system utilizing multiple computers as a server system, such as in a cloud computing environment. In the depicted embodiment, server computer 40 includes professional network server program 60 and career feedback program 70. In one embodiment, server computer 40 includes components described in reference to FIG. 3.

Professional network interface program 50 operates to visualize content, such as menus and icons, and to allow a user to interact with applications or resources accessible to client computer 30, such as professional network server program 60 and career feedback program 70 over network 20. In the depicted embodiment, professional network interface program 50 is a web browser. In another embodiment, professional network interface program 50 is a dedicated professional networking program.

In the depicted embodiment, professional network interface program 50 also operates to allow a user who has a registered account with the professional networking service to access content from professional network server program 60. Professional network interface program 50 sends data received from the user to professional network server program 60 over network 20. In another embodiment, professional network interface program 50 operates to send career data for a registered user at client computer 30 to career feedback program 70 over network 20. In yet another embodiment, professional network interface program 50 operates to send career data for a registered user to a storage repository (not shown) that is located on server computer 40.

Professional network server program 60 operates to provide a professional networking service that allows a plurality of registered users to each post a CV, communicate with other registered users, post employment opportunities, and respond to posted employment opportunities. In the depicted embodiment, professional network server program 60 is a web site hosted by server computer 40.

In the depicted embodiment, professional network server program 60 operates to receive a registered user's career data from professional network interface program 50 via network 20. Career data is a set of data that includes respective career goals and current skills for each registered user. Career goals may comprise information including, but not limited to, job opportunities, professional fields, and professional development areas that are of interest to the user. For example, a user's career goal a specific job title, such as elementary school principal. A career goal may include the user's professional field. For example, a user's professional field is art education. In yet another example, a career goal includes a five year plan detailing specific career goals the user would like to achieve within the next five years. A career goal, for example, is to become certified to teach in a certain state within the next five years.

In embodiments of the present invention, career goals may provide filters for excluding jobs and skills that the user would like to avoid. For example, a career goal may be to exclude career opportunities at museums and art galleries. A career goal may also specify a target income level. For example, a career goal is an income of at least $45,000 per year. A career goal may be any combination of these or other examples.

Current skills include skills that have already been acquired and developed by the user. An example of a current skill is 13 years of experience teaching art at the elementary school level. Current skills may also include a user's educational background. For example, a current skill is having a master's of fine arts (MFA) in visual arts. Current skills may include employment information. For example, employment information includes the companies and job titles that a user has previously held or currently holds. Current skills may also be recommended by other registered users. For example, a current skill of a user may be a skill for which another registered user has recommended the user.

In another embodiment, career data includes interactions the user has with the professional networking service hosted by professional network server program 60. For example, career data includes personal information about the user, such as the user's name and profession. In another example, career data includes posts that the user contributes to a forum provided by professional network server program 60.

In the depicted embodiment, professional network server program 60 also operates to store career data received from professional network interface program 50. Professional network server program 60 also receives career data from a plurality of registered users accessing professional network server program 60 from a plurality of computing devices (not shown) over network 20. In one embodiment, professional network server program 60 has access to content creating sets of related web pages. For example, a set of web pages includes profiles of registered users. A profile includes a name, occupational field, CV, and a list of contacts for a registered user associated with the profile, or profile owner. For example, a contact is a registered user who is a former colleague of the profile owner. In another example, a contact is a registered user who works in the same field as the profile owner but has never met the profile owner in person. A registered user may invite other registered users and non-registered users to connect with the registered user through the professional network service. If a non-registered user wishes to connect through the professional network service, the non-registered user must become a registered user. A non-registered user can register with the professional network service by providing information necessary to register with the professional network service to professional network program 60. Such information may include career data such as a name, contact information, and professional experiences and qualifications. In one embodiment, each profile is viewable to other registered users. In another embodiment, each profile is viewable only to registered users listed as contacts of the profile owner.

In the depicted embodiment, professional network server program 60 also operates to allow registered users to list career opportunities. A career opportunity can be, for example, a job, internship, co-op, or any other open position within an institution, such as a company, university, government agency, etc. A career opportunity includes responsibilities and required skills. For example, a responsibility may be teaching a painting class to children ages 7-10 years old. In one embodiment, registered users can view listed career opportunities, interact with the registered user who listed the career opportunity, and apply directly to the career opportunity. In one embodiment, the registered user who posts a career opportunity can view the CVs of other registered users to determine if the skills and experiences of one or more of the other registered users match the skills and experiences required for the listed career opportunity.

In another embodiment, professional network server program 60 creates an automated job search for each user of the professional network service. Professional network server program 60 compares each user's career data with each career opportunity posted to the website hosting the professional networking service. Professional network server program 60 sends an instruction to professional network interface program 50 over network 20 to display the results of the automated job search. In one embodiment, professional network server program 60 sends the results of automated job searches to career feedback program 70.

In the depicted embodiment, professional network server program 60 also sends career goals and current skills to career feedback program 70.

Career feedback program 70 operates to analyze a career opportunity to generate feedback for a user based on the user's current skills and career goals. In the depicted embodiment, career feedback program 70 receives career goals and current skills for a registered user from professional network server program 60. In another embodiment, career feedback program 70 accesses a storage repository (not shown) to determine career goals and current skills for a registered user. Career feedback program 70 receives an indication of a career opportunity from professional network server program 60. Career feedback program 70 compares the user's career goals and current skills to the responsibilities and required skills of the career opportunity. Career feedback program 70 determines if the user's goals and current skills match the responsibilities and required skills of the career opportunity. In one embodiment, career feedback program 70 resides on server computer 40. In other embodiments, career feedback program 70 may reside on another server computer, another computing device, or client computer 30, provided that career feedback program 70 is accessible to professional network server program 60, and provided that career feedback program 70 has access to professional network server program 60.

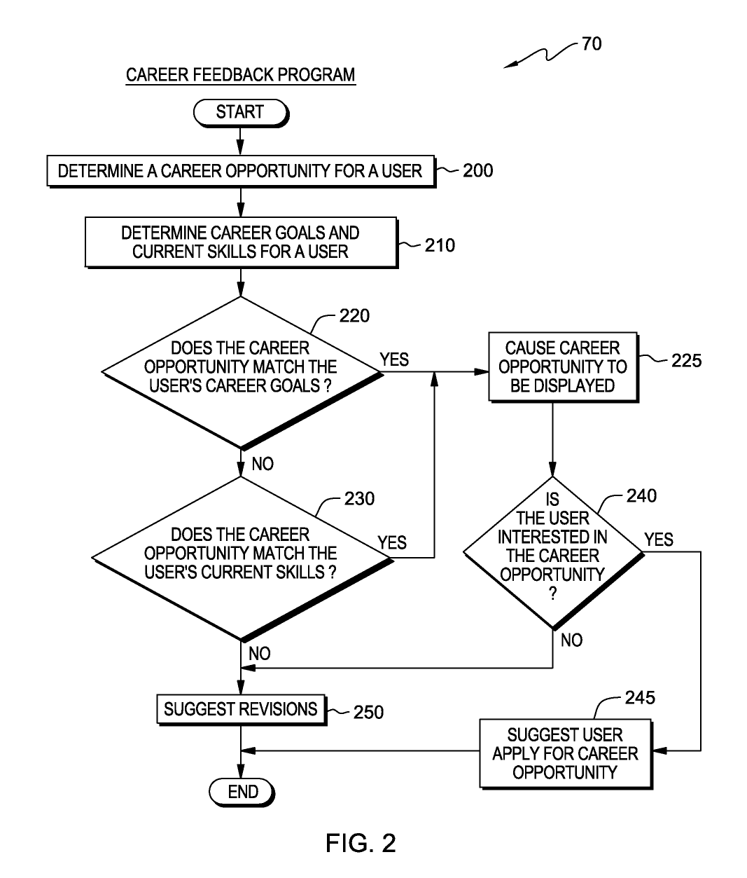

FIG. 2 depicts a flowchart of the steps of career feedback program 70 for analyzing a career opportunity to generate feedback for a user based on the user's current skills and career goals, in accordance with one embodiment of the present invention.

Initially, a user at client computer 30 is a registered user of the professional network service provided by professional network program 60. The user, using professional network interface program 50, accesses professional network server program 60 and enters career data. In the preferred embodiment, career data includes at least the user's career goals and current skills.

In one embodiment, professional network interface program 50 sends career data to professional network server program 60 over network 20. Professional network server program 60 receives the career data. Professional network server program 60 sends the career data to career feedback program 70. In another embodiment, professional network interface program 50 sends the career data to career feedback program 70 over network 20.

In step 200, career feedback program 70 determines a career opportunity for a user. In the preferred embodiment, career feedback program 70 continuously searches all career opportunities accessible to professional network server program 60. For example, career feedback program 70 determines a career opportunity for the user based on the user's field. In another example, career feedback program 70 determines a career opportunity for the user based on the user's geographical location.

In another embodiment, career feedback program 70 receives an indication of a career opportunity from professional network interface program 50. An indication of a career opportunity may be, for example, a message from a registered user who is a recruiter about an open position, such as high school art teacher. In another example, an indication of a career opportunity is a description of the career opportunity determined by professional network server program 60 during an automated job search. In the preferred embodiment, an indication of a career opportunity includes a description of the career opportunity. A description of a career opportunity includes responsibilities and required skills for the career opportunity.

In step 210, career feedback program 70 determines career goals and current skills for a user. In one embodiment, career feedback program 70 receives career goals and current skills for a user from professional network program 60. In another embodiment, career feedback program 70 receives career goals and current skills for a user from professional network interface program 50. In yet another embodiment, career feedback program 70 accesses a storage repository that stores the career goals and current skills for a user.

Career feedback program 70 determines if the career opportunity matches the user's career goals (decision 220).

In one embodiment, career feedback program 70 uses text analytics to parse through all available career opportunities and career goals based on keywords or common themes within career related entry descriptions or linked materials. Using natural language processing and at least one set of dictionaries and rules, career feedback program 70 can perform text analytics on individual employment related entries to create topics. Text analytics can be performed using an Unstructured Information Management Architecture (UIMA) application configured to analyze unstructured information to discover patterns relevant to career feedback program 70 by processing plain text and identifying entities or relations.

In the preferred embodiment, career feedback program 70 compares the user's career goals (received in step 200) to the description of the career opportunity (received in step 210) and generates a result that indicates whether there is a match, at least in part, between the at least one career opportunity and the user's career goals. For example, career feedback program 70 determines if the career opportunity is in the same field as the user's career goals. In such an example, career feedback program 70 determines that the high school art teaching position is in the same professional field as the user, which is art education. Career feedback program 70 may also determine if the career opportunity meets the user's desired minimum income. In another example, career feedback program 70 determines if the job title matches the user's desired job title.

If career feedback program 70 determines that the career opportunity matches the user's career goals, then career feedback program 70 proceeds to step 225 (decision 220, Yes branch). If career feedback program 70 determines that the career opportunity does not match the user's career goals, then career feedback program 70 proceeds to decision 230 (decision 220, No branch).

Career feedback program 70 determines if the career opportunity matches the user's current skills (decision 230) and generates a result that indicates whether there is a match, at least in part, between the at least one career opportunity and the user's current skills. In one embodiment, career feedback program 70 compares the user's current skills to the skills required for the career opportunity. For example, career feedback program 70 uses natural language processing to extract current skills. Career feedback program 70 uses NLP to compare the extracted current skills to the skills required for the career opportunity. Career feedback program 70 determines if at least one of the required skills for the career opportunity match at least one of the user's current skills. If career feedback program 70 determines that at least one of the required skills included in the description of the career opportunity matches at least one of the user's current skills, then career feedback program 70 proceeds to step 225 (decision 230, Yes branch). If career feedback program 70 determines that none of the skills included in the description of the career opportunity match the user's current skills, career feedback program 70 proceeds to step 250 (decision 230, No branch).

In step 225, career feedback program 70 causes the career opportunity to be displayed. In one embodiment, career feedback program 70 causes a modeless window to be displayed. A modeless window is a window that does not require a user to interact with it before the user can return to operating a parent application (e.g. career feedback program 70). The user can, for example, continue to interact with data career feedback program 70, professional networks server program 60, professional network interface program 50, or any other program accessible to client computer 30 while the modeless window is open.

Career feedback program 70 determines if the user is interested in the career opportunity (decision 240). In one embodiment, career feedback program 70 prompts the user to indicate if the user is interested in the career opportunity. For example, career feedback program 70 causes a modeless window to be displayed. In one embodiment, the modeless window includes a description of the career opportunity. In another embodiment, the modeless window lists at least one of the user's current skills that match the required skills for the career opportunity. If the user is interested in the opportunity, then career feedback program 70 proceeds to step 245 (decision 240, Yes branch). If the user is not interested in the career opportunity, career feedback program 70 proceeds to step 250 (decision 240, No branch).

In step 245, career feedback program 70 suggests the user apply for the career opportunity. In one embodiment, career feedback program 70 causes a modeless window to be displayed. The modeless window suggests that the user apply for the career opportunity. In one embodiment, the modeless window includes a hyperlink. A hyperlink is a reference to data that the user can directly follow by clicking. By selecting the hyperlink, the user can access a webpage where he or she may apply for the career opportunity.

In step 250, career feedback program 70 suggests that the user revise his or her career goals and current skills. Revisions, for example, include updating current skills, experiences, qualifications, and relevant coursework to better reflect the user's career goals and current skills. In another example, a revision includes adding a personal statement to the user's profile. Yet another revision may include updating the user's current employment information. In another example, a revision includes acquiring skills required for a career opportunity, such as acquiring certification. Another example may include taking a course to obtain skills required for a career opportunity. In another example, if the user has indicated that he or she is not interested in the career opportunity, career feedback program 70 suggests removing a career goal or current skill, such as the career goal or current skill that matched the career opportunity.

In one embodiment, career feedback program 70 displays a modeless window that includes suggested revisions. The user selects one of the suggested revisions displayed in the modeless window. Career feedback program 70 then causes the user's profile page to be displayed. In another embodiment, career feedback program 70 sends an instruction to professional network server program 60 to display the user's profile page. Professional network server program 60 receives the instruction from career feedback program 70 and displays the user's profile page. The user can then interact with his or her profile and make revisions to the profile. In another embodiment, the user views the suggested revisions displayed in the modeless window. The user closes the modeless window and interacts with professional network program 60.

In yet another embodiment, career feedback program 70 receives a request from the user to view the profile of a second user that has achieved the user's career goals. Career feedback program 70 causes the second user's profile to be displayed.

FIG. 3 depicts a block diagram of components of client computer 30 and server computer 40 in accordance with one embodiment of the present invention. It should be appreciated that FIG. 3 provides only an illustration of one implementation and does not imply any limitations with regard to the environments in which different embodiments may be implemented. Many modifications to the depicted environment may be made.

Client computer 30 and server computer 40 can each include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Professional network interface program 50 is stored in persistent storage 308 of client computer 30 for execution by one or more of the respective computer processors 304 of client computer 30 via one or more memories of memory 306 of client computer 30. Professional network server program 70 and career feedback program 70 are stored in persistent storage 308 of server computer 40 for execution and/or access by one or more of the respective computer processors 304 of server computer 40 via one or more memories of memory 306 of server computer 40. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media capable of storing program instructions or digital information.

The media used by persistent storage 308 may also be removable. For example, a removable hard drive may be used for persistent storage 308. Other examples include optical and magnetic disks, thumb drives, and smart cards inserted into a drive for transfer onto another computer-readable storage medium that is also part of persistent storage 308.

Communications unit 310, in these examples, provides for communications with other servers or devices. In these examples, communications unit 310 includes one or more network interface cards. Communications unit 310 may provide communications through the use of either or both physical and wireless communications links. Professional network interface program 50 may be downloaded to persistent storage 308 of client computer 30 through the communications unit 310 of client computer 30. Professional network server program 60 and career feedback program 70 may be downloaded to persistent storage 308 of server computer 40 through the communications unit 310 of server computer 40.

I/O interface(s) 312 allows for input and output of data with other devices that may be connected to client computer 30 or server computer 40. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., professional network interface program 50, can be stored on such portable computer-readable storage media and can be loaded onto persistent storage 308 of client computer 30, respectively, via the respective I/O interface(s) 312 of client computer 30. Software and data used to practice embodiments of the present invention, e.g. professional network server program 60 and career feedback program 70, can be stored on such portable computer-readable storage media and can be loaded onto persistent storage 308 of server computer 40 via I/O interface(s) 312 of server computer 40.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for analyzing a career opportunity to generate feedback for a user, the method comprising the steps of:
one or more processors determining at least one career opportunity;
one or more processors receiving a set of data for a user;
one or more processors comparing the at least one career opportunity to the set of data; and
one or more processors suggesting at least one revision to the set of data based, at least in part, on a result of comparing the at least one career opportunity to the set of data, wherein the result indicates whether there is a match, at least in part, between the at least one career opportunity and the set of data.

2. The method of claim 1, wherein the set of data for a user comprises a career goal and a current skill of the user.

3. The method of claim 2, wherein the step of the one or more processors comparing the career opportunity to the set of data comprises:
one or more processors determining the at least one career opportunity does not match the career goal of the user; and
one or more processors, in response to determining that the at least one career opportunity does not match the career goal of the user, determining whether the at least one career opportunity matches the current skill of the user.

4. The method of claim 1, further comprising:
one or more processors causing the at least one career opportunity to be displayed; and
one or more processors receiving an indication that the user is not interested in the at least one career opportunity.

5. The method of claim 4, wherein the step of one or more processors suggesting at least one revision to the set of data comprises:
one or more processors, in response to receiving the indication that the user is not interested in the at least one career opportunity, suggesting removal of specific data from the set of data corresponding to the user.

6. The method of claim 1, further comprising:
one or more processors causing the at least one career opportunity to be displayed; and
one or more processors receiving an indication that the user is interested in the at least one career opportunity.

7. The method of claim 6, wherein the step of one or more processors suggesting at least one revision to the set of data comprises:
one or more processors, in response to receiving the indication that the user is interested in the at least one career opportunity, suggesting addition of specific data to the set of data corresponding to the user.

8. A computer program product for analyzing a career opportunity to generate feedback for a user, the computer program product comprising:
one or more computer readable storage media and program instructions stored on the one or more computer readable storage media, the program instructions comprising:
program instructions to determine at least one career opportunity;
program instructions to receive a set of data for a user;
program instructions to compare the at least one career opportunity to the set of data; and
program instructions to suggest at least one revision to the set of data based, at least in part, on a result of comparing the at least one career opportunity to the set of data, wherein the result indicates whether there is a match, at least in part, between the at least one career opportunity and the set of data.

9. The computer program product of claim 8, wherein the set of data for a user comprises a career goal and a current skill of the user.

10. The computer program product of claim 8, wherein program instructions to compare the career opportunity to the set of career data comprise:
program instructions to determine the at least one career opportunity does not match the career goal of the user; and
program instructions to, in response to program instructions to determine that the at least one career opportunity does not match the career goal of the user, determine whether the at least one career opportunity matches the current skill of the user.

11. The computer program product of claim 8, further comprising:
program instructions, stored on the one or more computer readable storage media, to cause the at least one career opportunity to be displayed; and
program instructions, stored on the one or more computer readable storage media, to receive an indication that the user is not interested in the at least one career opportunity.

12. The computer program product of claim 11, wherein program instructions to suggest at least one revision to the set of data comprise:
program instructions to, in response to receiving the indication that the user is not interested in the at least one career opportunity, suggest removal of specific data from the set of data corresponding to the user.

13. The computer program product of claim 8, further comprising:
program instructions, stored on the one or more computer readable storage media, to cause the at least one career opportunity to be displayed; and
program instructions, stored on the one or more computer readable storage media, to receive an indication that the user is interested in the at least one career opportunity.

14. The computer program product of claim 13, wherein program instructions to suggest at least one revision to the set of data comprise:
program instructions to, in response to receiving the indication that the user is interested in the at least one career opportunity, suggest addition of specific data to the set of data corresponding to the user.

15. A computer system for analyzing a career opportunity to generate feedback for a user, the computer system comprising:
one or more computer processors;
one or more computer readable storage media;
program instructions stored on the computer readable storage media for execution by at least one of the one or more processors, the program instructions comprising:
program instructions to determine at least one career opportunity;
program instructions to receive a set of data for a user;
program instructions to compare the at least one career opportunity to the set of data; and
program instructions to suggest at least one revision to the set of data based, at least in part, on a result of comparing the at least one career opportunity to the set of data, wherein the result indicates whether there is a match, at least in part, between the at least one career opportunity and the set of data.

16. The computer system of claim 15, wherein the set of data for a user comprises a career goal and a current skill of the user.

17. The computer system of claim 15, wherein program instructions to compare the career opportunity to the set of career data comprise:
program instructions to determine the at least one career opportunity does not match the career goal of the user; and
program instructions to, in response to program instructions to determine that the at least one career opportunity does not match the career goal of the user, determine whether the at least one career opportunity matches the current skill of the user.

18. The computer system of claim 15, further comprising:
program instructions, stored on the computer readable storage media for execution by at least one of the one or more processors, to cause the at least one career opportunity to be displayed; and
program instructions, stored on the computer readable storage media for execution by at least one of the one or more processors, to receive an indication that the user is not interested in the at least one career opportunity.

19. The computer system of claim 18, wherein program instructions to suggest at least one revision to the set of data comprise:
program instructions to, in response to receiving the indication that the user is not interested in the at least one career opportunity, suggest removal of specific data from the set of data corresponding to the user.

20. The computer system of claim 15, further comprising:
program instructions, stored on the computer readable storage media for execution by at least one of the one or more processors, to cause the at least one career opportunity to be displayed; and
program instructions, stored on the computer readable storage media for execution by at least one of the one or more processors, to receive an indication that the user is interested in the at least one career opportunity.
